(19) United States
(12) Patent Application Publication
(10) Pub. No.: US 2024/0277078 A1
(43) Pub. Date: Aug. 22, 2024

(54) AEROSOL FORMING DEVICE

(71) Applicant: Shenzhen Merit Technology Co., Ltd, Shenzhen (CN)

(72) Inventors: Peng CHENG, Shenzhen (CN); Yancheng LIAO, Shenzhen (CN)

(21) Appl. No.: 18/653,994

(22) Filed: May 3, 2024

Related U.S. Application Data
(63) Continuation of application No. PCT/CN2022/127951, filed on Oct. 27, 2022.

(30) Foreign Application Priority Data
Nov. 3, 2021 (CN) 202111291754.3

(51) Int. Cl. A24F 40/85; A24F 40/20; A24F 40/46; A24F 40/60; H05B 3/42

(52) U.S. Cl. CPC A24F 40/85; A24F 40/20; A24F 40/46; A24F 40/60; H05B 3/42

(57) ABSTRACT

An aerosol forming device includes: a shell formed with an accommodating cavity at an end; a heating assembly detachably accommodated in the accommodating cavity; and an elastic mechanism disposed in the shell. The heating assembly is formed with a heating cavity for accommodating an aerosol forming substrate. The elastic mechanism has a locked position and a released position. When the elastic mechanism is switched from the locked position to the released position, the elastic mechanism pushes the heating assembly to move toward an opening of the accommodating cavity.

### CROSS-REFERENCE TO PRIOR APPLICATION

This application is a continuation of International Patent Application No. PCT/CN2022/127951, filed on Oct. 27, 2022, which claims priority to Chinese Patent Application No. 202111291754.3, filed on Nov. 3, 2021. The entire disclosure of both applications is hereby incorporated by reference herein.

### FIELD

The present invention relates to aerosol forming field, and more specifically, to an aerosol forming device.

### BACKGROUND

A heat-not-burn device is an aerosol forming device that heats an aerosol forming material in a low-temperature heat-not-burn manner to form inhalable aerosol. Currently, in the heat-not-burn device, a heater like a heating sheet is usually inserted into an aerosol forming substrate to perform heating, and a heating temperature is controlled to volatilize components in the aerosol forming substrate to generate aerosol for inhalation by a person.

The aerosol forming substrate tends to become sticky after heating and forms a residue on the heater. This affects a heating effect during use by the heater a next time. For example, a burning smell is generated. Therefore, after the heater has been used for a period of time, it is necessary to clean the heater or replace a new heater.

### SUMMARY

In an embodiment, the present invention provides an aerosol forming device, comprising: a shell formed with an accommodating cavity at an end; a heating assembly detachably accommodated in the accommodating cavity; and an elastic mechanism disposed in the shell, wherein the heating assembly is formed with a heating cavity configured to accommodate an aerosol forming substrate, wherein the elastic mechanism has a locked position and a released position, and wherein, when the elastic mechanism is switched from the locked position to the released position, the elastic mechanism is configured to push the heating assembly to move toward an opening of the accommodating cavity.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a three-dimensional schematic structural diagram of an aerosol forming device when a dust cover is closed according to some embodiments of the present invention;

FIG. 2 is a three-dimensional schematic structural diagram of the aerosol forming device shown in FIG. 1 when the dust cover is open and an aerosol forming substrate is inserted;

FIG. 3 is a schematic structural exploded view of the aerosol forming device shown in FIG. 2;

FIG. 4 is a schematic structural exploded view of a heating assembly in FIG. 2;

FIG. 5 is a schematic structural cross-sectional view of a heating assembly in FIG. 2;

FIG. 6 is a schematic structural exploded view of an elastic mechanism in FIG. 2;

FIG. 7 is a longitudinal cross-sectional schematic diagram of the aerosol forming device shown in FIG. 2 along A-A;

FIG. 8 is a longitudinal cross-sectional schematic diagram of the aerosol forming device shown in FIG. 2 along A-A at an upward movement to a second position after unlocking;

FIG. 9 is a schematic transverse cross-sectional view of the aerosol forming device shown in FIG. 2;

FIG. 10 is a longitudinal cross-sectional schematic diagram of the aerosol forming device shown in FIG. 2 along B-B; and

FIG. 11 is a longitudinal cross-sectional schematic diagram of the aerosol forming device shown in FIG. 2 along B-B at an upward movement to a second position after unlocking.

### DETAILED DESCRIPTION

In an embodiment, the present invention provides an improved aerosol forming device for the foregoing deficiencies in the prior art.

In an embodiment, the present invention provides an aerosol forming device that includes a shell formed with an accommodating cavity at an end, a heating assembly detachably accommodated in the accommodating cavity, and an elastic mechanism disposed in the shell. The heating assembly is formed with a heating cavity used for accommodating an aerosol forming substrate. An upper cover assembly is formed with an insertion hole for insertion of the aerosol forming substrate.

The elastic mechanism has a locked position and a released position. When the elastic mechanism is switched from the locked position to the released position, the elastic mechanism can push the heating assembly to move toward an opening of the accommodating cavity.

In some embodiments, the heating assembly includes a heating tube formed with the heating cavity inside and a heating element extending into the heating cavity.

In some embodiments, the heating element is a cylinder.

In some embodiments, the heating assembly includes a base, and the heating element is fastened on the base and is accommodated in the heating cavity.

In some embodiments, an electrical contact electrically connected to the heating element is disposed on a surface of the heating assembly away from the heating element.

In some embodiments, the aerosol forming device further includes an elastic electrode disposed in the shell and is used for contact and conduction with the electrical contact.

In some embodiments, the aerosol forming device further includes an upper cover assembly detachably accommodated in the accommodating cavity, and the upper cover assembly is formed with an insertion hole for insertion of the aerosol forming substrate; and
when the elastic mechanism is in the released position, the elastic mechanism is capable of pushing the heating assembly and the upper cover assembly to move toward the opening of the accommodating cavity.

In some embodiments, an upper end of the heating assembly extends into the insertion hole, and the upper cover assembly can press the heating assembly, to lock a position of the heating assembly in the accommodating cavity.

In some embodiments, an inner wall surface of the insertion hole protrudes inward to form a positioning portion, an outer edge of the upper end of the heating assembly protrudes outward to form a limiting flange, and the limiting flange is capable of being pressed by the positioning portion to push the heating assembly to move.

In some embodiments, the aerosol forming device further includes a sliding member slidably disposed in the shell, and the elastic mechanism pushes the sliding member to move, to push the upper cover assembly and the heating assembly to move.

In some embodiments, the sliding member is magnetically connected to the upper cover assembly.

In some embodiments, an accommodating hole is formed in the sliding member, and the heating assembly is sleeved inside the accommodating hole.

In some embodiments, a limiting structure is disposed in the sliding member, to keep the sliding member from being detached from the shell.

In some embodiments, the limiting structure is fastened to the shell, and the limiting structure includes a limiting pillar slidably disposed in the sliding member and a limiting member transversely extending out of the limiting pillar.

In some embodiments, the aerosol forming device further includes a second magnetic member that is disposed at the limiting member and is used for attracting the upper cover assembly.

In some embodiments, the elastic mechanism includes a first elastic assembly used for pushing the heating assembly to move and a second elastic assembly used for locking or releasing the first elastic assembly.

In some embodiments, the first elastic assembly includes a push rod vertically movably disposed in the shell and a first elastic member connected to the push rod, and the second elastic assembly includes a locking member transversely movably disposed in the shell and a second elastic member connected to the locking member; and when the elastic mechanism is in the locked position, the push rod and the locking member are clamped with each other.

In some embodiments, a first clamp portion and a second clamp portion that are in snap-fit with each other are respectively formed on the push rod and the locking member; and the first clamp portion and the second clamp portion are engaged with or disengaged from each other to lock or release the push rod.

In some embodiments, a press key is disposed on a surface of the shell, and the press key is capable of pressing the locking member, to enable the locking member to release locking of the push rod.

In some embodiments, the push rod includes a first rod section, a second rod section, and a third rod section that are sequentially connected longitudinally from top to bottom, and an external cross-sectional size of the second rod section is greater than external cross-sectional sizes of the first rod section and the third rod section.

In some embodiments, the first elastic member is a spring and is sleeved on the third rod section.

### Beneficial Effects

The implementation of the present invention has at least the following beneficial effects: The heating assembly is detachably disposed. After the aerosol forming device has been used for a period of time, the elastic mechanism may be operated to release the heating assembly, and then the heating assembly is removed, to clean the heating assembly or replace a new heating assembly.

In order to have a clearer understanding of the technical features, the objectives, and the effects of the present invention, specific implementations of the present invention are now illustrated in detail with reference to the accompanying drawings.

In the description of the present invention, it should be understood that, orientation or position relationships indicated by terms such as “front”, “rear”, “upper”, “lower”, “left”, “right”, “top”, “bottom”, “inner”, and “outer” are orientation or position relationship shown based on the accompanying drawings or generally placed orientation or location relationship of the product of the present invention during use, and are merely used for describing the technical solutions, rather than indicating or implying that the mentioned apparatus or element should have a particular orientation or be constructed and operated in a particular orientation, and therefore, should not be construed as a limitation to the present invention. In addition, the terms “vertical”, “horizontal”, “longitudinal”, “transverse”, and similar expressions used in the present invention are only for purposes of illustration but not indicate a unique implementation.

It is to be further noted that, unless otherwise explicitly specified and defined, terms such as “mounted”, “connected”, “connection”, “fixed”, and “disposed” should be understood in a broad sense. For example, the connection may be a fixed connection, a detachable connection, or an integral connection; or the connection may be a mechanical connection or may be an electrical connection; or the connection may be a direct connection, an indirect connection through an intermediate, or internal communication between two elements or an interaction relationship between two elements. When an element is referred to as being “above” or “below” another element, that element can be “directly” or “indirectly” above another element, or there may be one or more intervening elements. Terms “first”, “second”, “third”, and the like are used merely for the purpose of describing the technical solutions, and shall not be construed as indicating or implying relative importance or implying a quantity of indicated technical features. Therefore, a feature restricted by “first”, “second”, “third”, or the like may explicitly indicate or implicitly include one or more such features. A person of ordinary skill in the art may understand the specific meanings of the foregoing terms in the present invention according to specific situations.

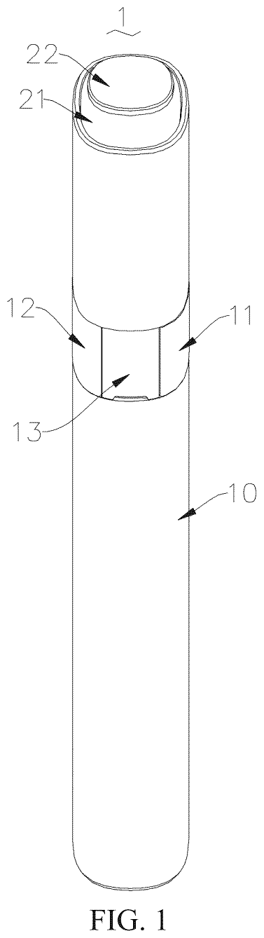

FIG. 1 to FIG. 11 show an aerosol forming device 1 according to some embodiments of the present invention. The aerosol forming device 1 may be configured to perform low-temperature baking and heating on an aerosol forming substrate 9 inserted in aerosol forming device, to release aerosol extracts in the aerosol forming substrate 9 in a not-burn state. The aerosol forming device 1 may be approximately an elliptic cylinder, and the aerosol forming substrate 9 may be a cylinder and may include a solid substrate of a plant leaf material. In other embodiments, the aerosol forming device 1 is not limited to being an elliptic cylinder, or may be a cylinder, a rectangular cylinder, or another shape.

As shown in FIG. 1 to FIG. 3 and FIG. 7, the aerosol forming device 1 may include a tube-shaped shell 10 and an upper cover assembly 20, a heating assembly 30, a battery 70, and a circuit board 80 that are accommodated in the shell 10. The battery 70 may be disposed at a lower portion of the shell 10, and configured to supply power to the heating assembly 30. The circuit board 80 may be disposed at a middle portion of the shell 10, and a related control circuit is arranged on the circuit board 80. The control circuit is electrically connected to the battery 70 and the heating assembly 30, and is configured to control the battery 70 to supply power to the heating assembly 30. A switch 13 and a display 12 may further be disposed on the shell 10. The switch 13 is configured to receive an operation of a user, to turn on the circuit board 80 to control the battery 70 to supply power to the heating assembly 30. The display 12 may be configured to display a state of the aerosol forming device 1 or prompt the user.

An accommodating cavity 100 is formed at an upper end of the shell 10, an opening 101 is defined in a top portion of the accommodating cavity 100, and the upper cover assembly 20 and the heating assembly 30 are both detachably accommodated in the accommodating cavity 100. An insertion hole 210 for inserting the aerosol forming substrate 9 is formed in the upper cover assembly 20, a heating cavity 310 used for accommodating the aerosol forming substrate 9 is formed in the heating assembly 30, and the aerosol forming substrate 9 may be inserted into the heating cavity 310 through the insertion hole 210. After the heating assembly 30 is energized to generate heat, heat may be transferred to the aerosol forming substrate 9, to implement heating of the aerosol forming substrate 9. A heating manner of the heating assembly 30 is not limited. For example, the heating manner may be resistive heating, electromagnetic heating, infrared radiation heating, chemical heating, or the like.

The upper cover assembly 20 is detachably mounted in the accommodating cavity 100, and is slidable back and forth between a first position and a second position. The upper cover assembly 20 includes an upper cover 21 vertically slidably disposed in the accommodating cavity 100 and a dust cover 22 horizontally slidably disposed on an upper side of the upper cover 21. The insertion hole 210 is formed longitudinally penetrating the upper cover 21. A shape and a size of the insertion hole 210 may adapt to the aerosol forming substrate 9. When the upper cover assembly 20 is at the first position, the upper cover 21 is accommodated in the accommodating cavity 100. When the upper cover assembly 20 is at the second position, the upper cover 21 is at least partially exposed from the accommodating cavity 100. In this case, the upper cover assembly 20 may be pulled out of the accommodating cavity 100.

The dust cover 22 is configured to block or expose the insertion hole 210. When the aerosol forming device 1 does not need to be used, the dust cover 22 may be pushed to block the insertion hole 210, to keep dust from entering the insertion hole 210. When the device needs to be used, the dust cover 22 may be pushed to expose the insertion hole 210, to facilitate the insertion of the aerosol forming substrate 9 through the insertion hole 210.

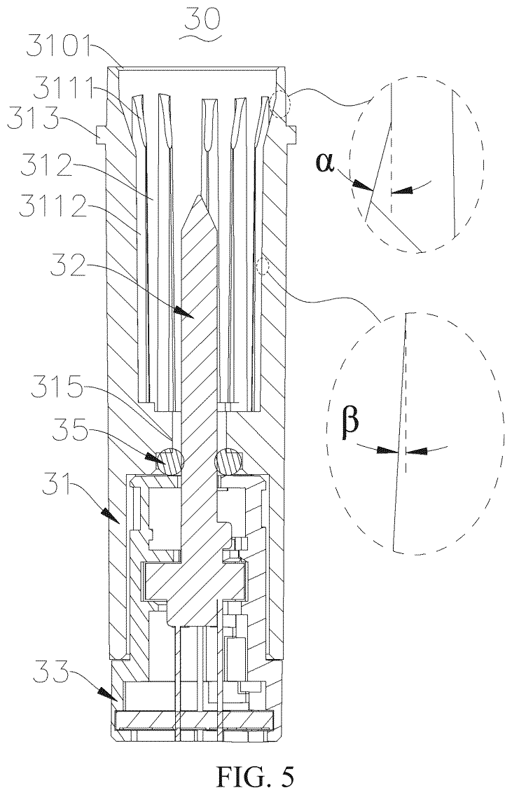

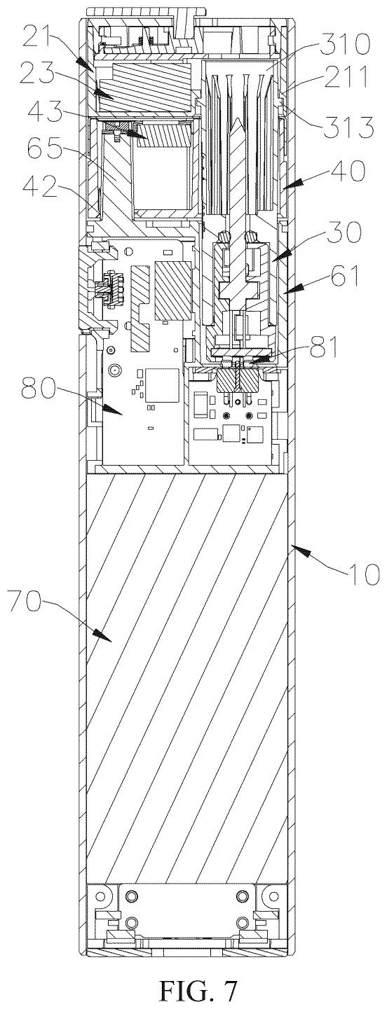

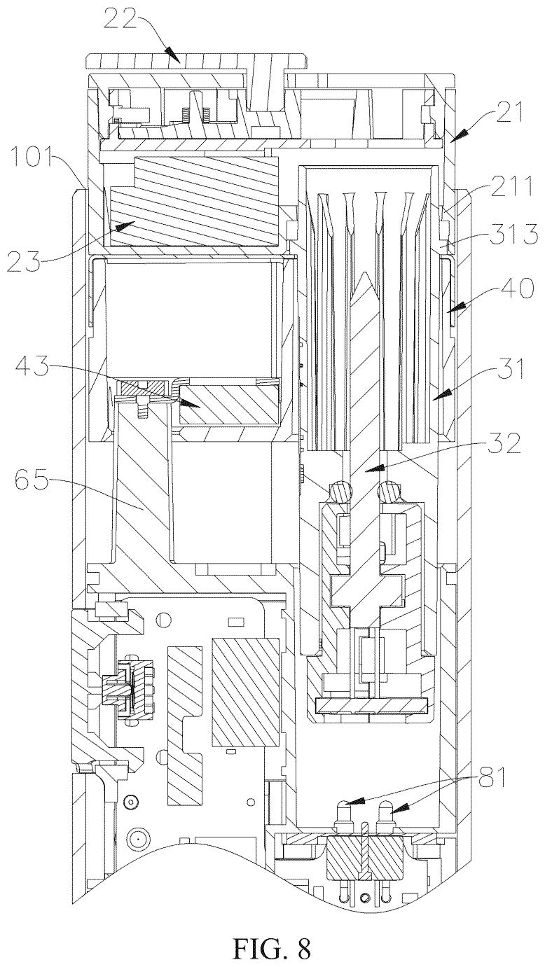

As shown in FIG. 5, FIG. 7, and FIG. 8, the heating assembly 30 is detachably mounted in the accommodating cavity 100, and is slidable back and forth between the first position and the second position. In some embodiments, the heating assembly 30 and the upper cover assembly 20 are detachably disposed, and an upper end of the heating assembly 30 may extend into the insertion hole 210. A positioning portion 211 may further be formed in the insertion hole 210. The positioning portion 211 fits the upper end of the heating assembly 30, to enable the upper cover assembly 20 to press down and lock the heating assembly 30. The positioning portion 211 may be formed by an inner wall surface of the insertion hole 210 extending inwardly. In this embodiment, two positioning portions 211 are provided, and the two positioning portions 211 are respectively located on two sides of the insertion hole 210 in a circumferential direction. In other embodiments, a plurality of positioning portions 211 may be provided. In some other embodiments, one positioning portion 211 may be provided and is annular. In other embodiments, the heating assembly 30 and the upper cover assembly 20 are not limited to being assembled together in a detachable manner. For example, the heating assembly 30 and the upper cover assembly 20 may be integrally formed.

The heating assembly 30 may include a heating tube 31, a base 33 disposed at a bottom of the heating tube 31, and a heating element 32 disposed at the base 33. The heating tube 31 is tube-shaped, and an inner wall surface of the heating tube defines the heating cavity 310 used for accommodating the aerosol forming substrate 9. The inner wall surface of the heating tube 31 may protrude inward to form an annular protrusion 315. When the aerosol forming substrate 9 is accommodated in the heating cavity 310, a lower end surface of the aerosol forming substrate 9 may be pressed against an upper end surface of the annular protrusion 315. A limiting flange 313 fitting the positioning portion 211 may be formed on an outer-wall surface of an upper end of the heating tube 31. The limiting flange 313 may be pressed by the positioning portion 211 to push the heating assembly 30 to move downward, and may be pushed by a sliding member 40 to push the heating assembly 30 to move upward. In some embodiments, the limiting flange 313 may be annular and formed by the outer-wall surface of the upper end of the heating tube 31 protruding outward in a radial direction. A lower end surface of the positioning portion 211 may be pressed against the limiting flange 313 to press the upper cover assembly 20 downward and may push the heating assembly 30 to move downward in a direction away from the opening 101 of the accommodating cavity 100. In other embodiments, the positioning portion 211 may be pressed against the upper end of the heating tube 31 surface, so that the limiting flange 313 may not be disposed on the heating tube 31.

In some embodiments, an inner surface of a cavity wall of the heating cavity 310 may further protrude inwardly to form at least two airway ribs 311. Each airway rib 311 extends in an axial direction of the heating cavity 310. After the aerosol forming substrate 9 is accommodated in the heating cavity 310, an outer surface of the aerosol forming substrate 9 may be pressed against at least one group of two airway ribs 311. An airway 312 for a gas to flow through may be formed between the outer surface of the aerosol forming substrate 9 and the at least one group of two airway ribs 311. Specifically, a gap is formed between the outer surface of the aerosol forming substrate 9 and the inner surface of the cavity wall of the heating cavity 310 between the at least one group of two airway ribs 311. The gap forms the airway 312. In this way, it can be ensured that an airflow flows smoothly during inhalation. Preferably, a plurality of airway ribs 311 are provided. The plurality of airway ribs 311 may be distributed at equal intervals in a circumferential direction of the heating cavity 310. In some embodiments, the number of the airway ribs 311 ranges from 6 to 12. One airway 312 is formed between the outer surface of the aerosol forming substrate 9 and each of every two adjacent airway ribs 311, so that an airflow can flow more smoothly during inhalation.

In some embodiments, inner contours of the plurality of airway ribs 311 in a same horizontal cross-section are located at a same circumference. The heating cavity 310 has a first end and a second end that are disposed opposite in the axial direction. The first end has a cavity opening 3101 and is used for inserting the aerosol forming substrate 9. That is, the first end is an end close to the upper cover assembly 20, and the second end is an end close to the base 33. Diameters of circles defined by inner contours of the plurality of airway ribs 311 in same horizontal cross-sections in a direction from the first end to the second end may gradually decrease. In this way, a guide effect during the insertion of the aerosol forming substrate 9 may be formed. In this embodiment, each airway rib 311 may include a first rib section 3111 and a second rib section 3112 connected to a lower end of the first rib section 3111 in an axial direction. The first rib section 3111 and the second rib section 3112 may have different slope angles. A slope angle α of the first rib section 3111 may be greater than or equal to a slope angle β of the second rib section 3112. In some embodiments, the slope angle α of the first rib section 3111 may range from 10 degrees to 40 degrees, and the slope angle β of the second rib section 3112 may range from 1 degree to 10 degrees. The slope angle of the first rib section 3111 located above is large, so that quick feeding of the aerosol forming substrate 9 can be facilitated. The slope angle of the second rib section 3112 located below is small, so that circumferential positioning of the aerosol forming substrate 9 can be implemented, and the airway 312 for a gas to flow is formed. In other embodiments, each airway rib 311 may be formed by at least three rib sections sequentially connected in the axial direction. The at least three rib sections may have different slope angles. The slope angle of one rib section located above may be greater than or equal to the slope angle of one rib section located below the rib section.

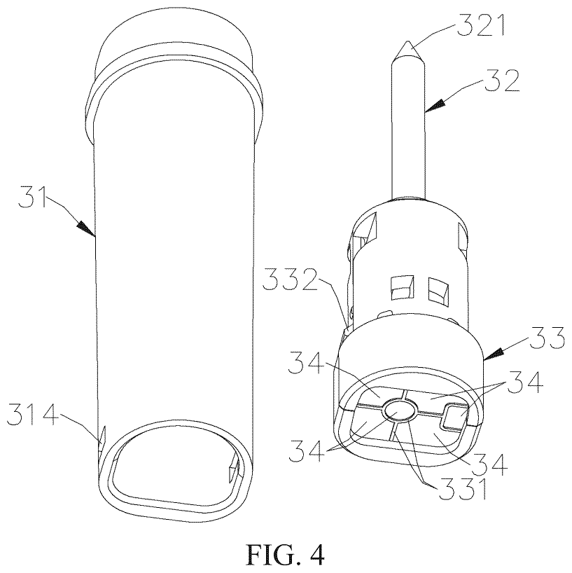

As shown in FIG. 4, the base 33 may be embedded at a bottom opening of the heating tube 31, and may be snap connected to the heating tube 31. Specifically, an outer circumferential surface of the base 33 may protrude outward to form at least one buckle portion 332. At least one clamping groove 314 is formed on the heating tube 31 corresponding to the at least one buckle portion 332. The at least one buckle portion 332 and the at least one clamping groove 314 may be buckled to each other, so that the heating tube 31 and the base 33 are buckled and fastened to each other. In this embodiment, two clamping grooves 314 are provided and may be respectively disposed on two sides of the heating tube 31 in a circumferential direction. Correspondingly, two buckle portions 332 are respectively formed on two sides of the base 33 in a circumferential direction corresponding to the two clamping grooves 314. In other embodiments, the heating tube 31 and the base 33 may be integrally formed.

The heating element 32 may be a sheet or a pillar. A lower end of the heating element 32 may be inserted in the base 33 for fastening. An upper end of the heating element 32 is accommodated in the heating cavity 310 and may be inserted into the aerosol forming substrate 9 to heat the aerosol forming substrate 9. In this embodiment, the heating element 32 may be cylindrical and may have a conical tip portion 321. The conical tip portion 321 may facilitate the insertion into the aerosol forming substrate 9. Because the heating element 32 is cylindrical, after the aerosol forming substrate 9 is heated, the aerosol forming substrate 9 may be manually rotated, to separate the aerosol forming substrate 9 from a sticky part after the heating of the heating element 32 and then pull out the aerosol forming substrate 9.

As shown in FIG. 4, FIG. 7, and FIG. 8, in some embodiments, the aerosol forming device 1 may further include at least two elastic electrodes 81 that are disposed in the shell 10 and are electrically connected to the circuit board 80. At least two electrical contacts 34 electrically connected to the heating element 32 may be disposed on a surface of the base 33 opposite to the heating cavity 310, that is, a bottom surface of the base 33. The heating element 32 may be in contact and conduction with or separated and disconnected from the at least two elastic electrodes 81 through the at least two electrical contacts 34. Further, a plurality of electrical contacts 34 and a plurality of elastic electrodes 81 may be provided. The plurality of electrical contacts 34 and the plurality of elastic electrodes 81 may further be configured to electrically connect to a temperature detection element and other electronic components that are disposed on the heating element 32.

Further, as shown in FIG. 5, in some embodiments, the heating assembly 30 may further include a seal ring 35. The seal ring 35 may be made of silicone or another elastic material. The seal ring 35 may be sleeved outside the heating element 32 in a sealed manner, and clamped between a lower end surface of the annular protrusion 315 and an upper end surface of the base 33.

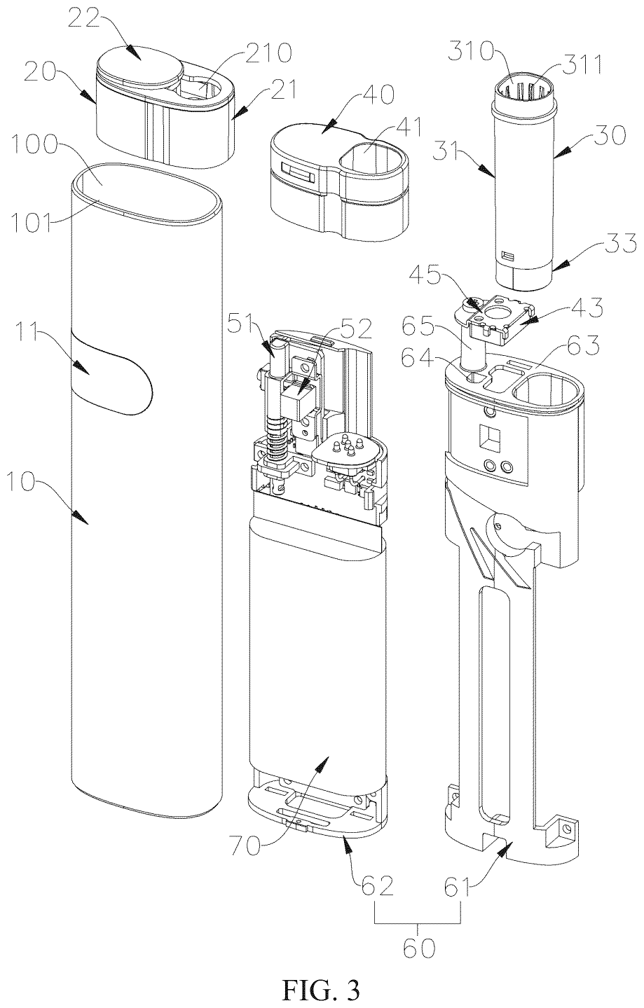

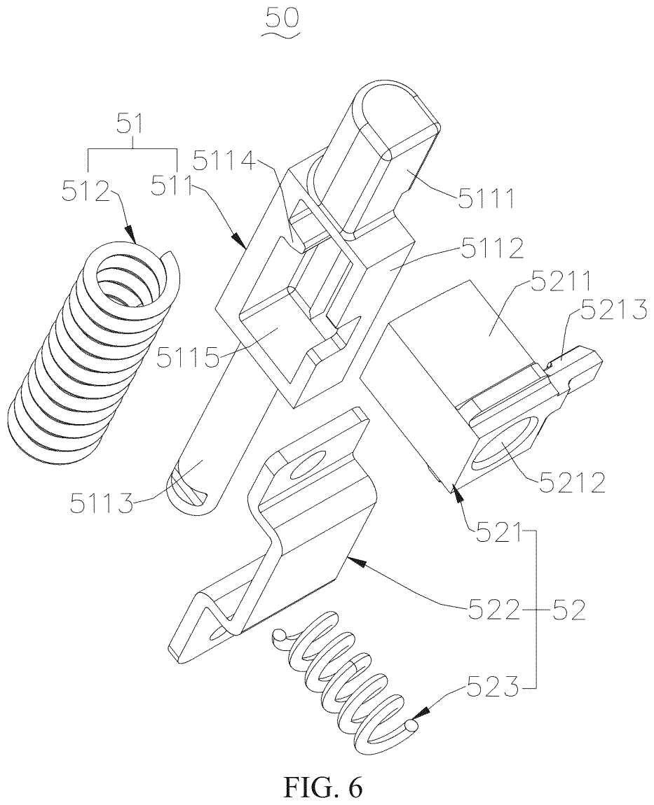

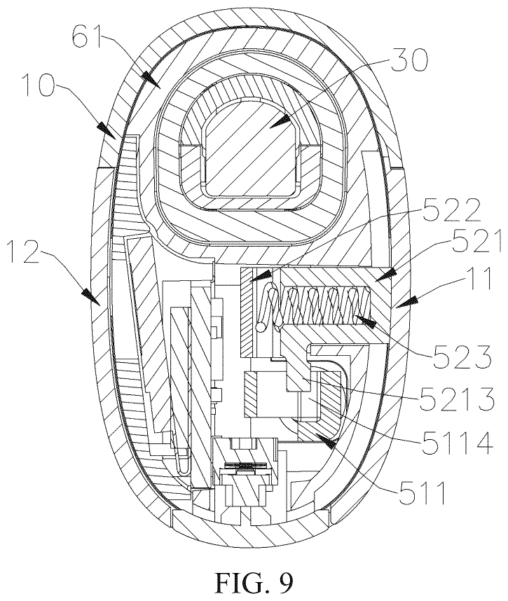

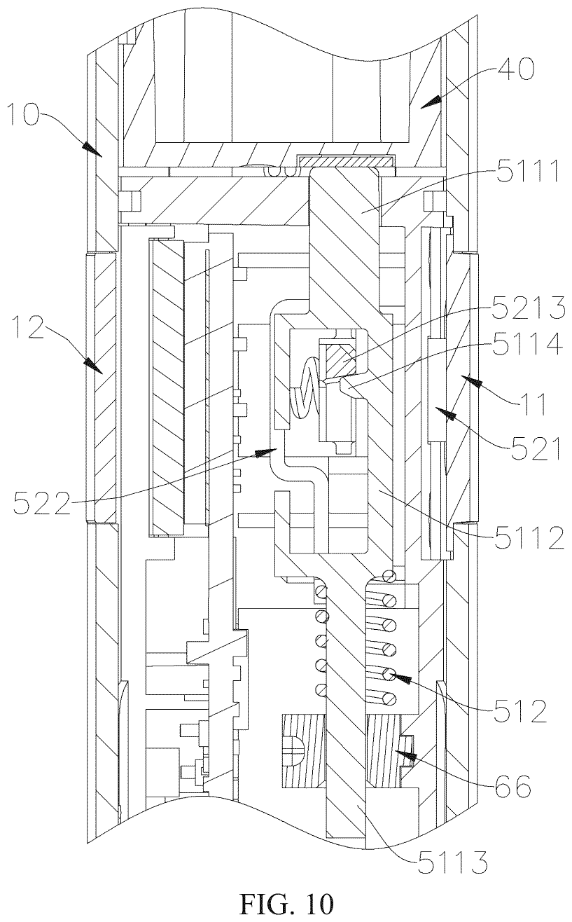

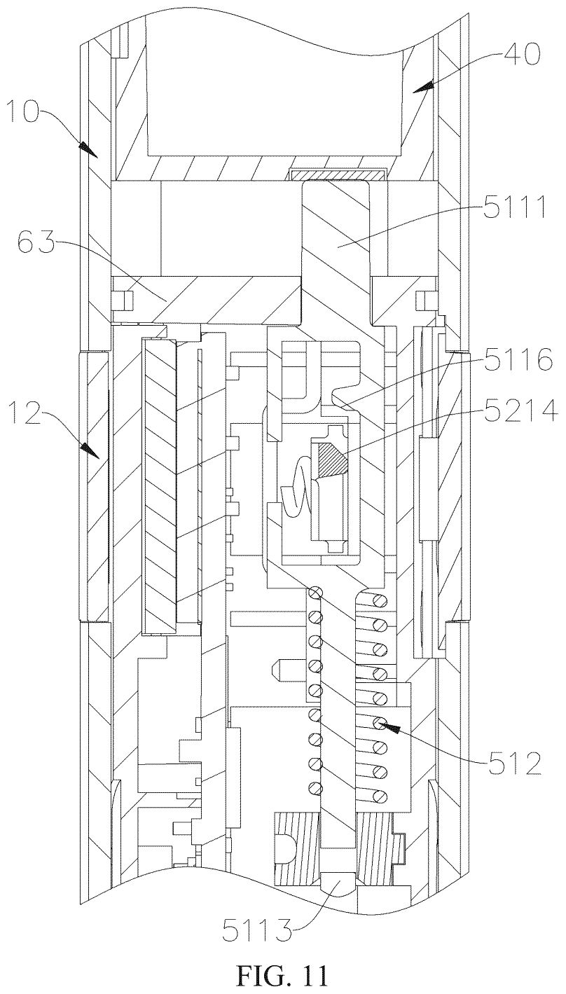

As shown in FIG. 3, FIG. 6, FIG. 9, FIG. 10, and FIG. 11, the aerosol forming device 1 may further include an elastic mechanism 50 disposed in the shell 10, a bracket assembly 60 disposed in the shell 10, and the sliding member 40 slidably disposed in the shell 10. The elastic mechanism 50 has a locked position and a released position. When the elastic mechanism 50 is switched from the locked position to the released position, the elastic mechanism 50 can push the upper cover assembly 20 and the heating assembly 30 to move upward toward the opening 101 of the accommodating cavity 100.

In some embodiments, the elastic mechanism 50 may include a first elastic assembly 51 and a second elastic assembly 52 that fit each other. The first elastic assembly 51 is supported below the sliding member 40, and can push the sliding member 40 to move upward, and may be pressed by the sliding member 40 to move downward. The first elastic assembly 51 may include a push rod 511 vertically movably disposed in the shell 10 and a first elastic member 512 connected to the push rod 511. The second elastic assembly 52 is configured to lock or release the first elastic assembly 51, and may include a locking member 521 transversely movably disposed in the shell 10 and a second elastic member 523 connected to the locking member 521. A first clamp portion 5114 and a second clamp portion 5213 that are in snap-fit with each other may be respectively formed on the push rod 511 and the locking member 521. The first clamp portion 5114 and the second clamp portion 5213 are engaged with or disengaged from each other, to implement locking or release of the first elastic assembly 51. When the push rod 511 and the locking member 521 are clamped to each other, an upper end surface of the first clamp portion 5114 abuts against a lower end surface of the second clamp portion 5213 under the action of elastic forces of the first elastic member 512 and the second elastic member 523, to lock the first elastic assembly 51. When the locking member 521 moves inward transversely under the action of an external force, the second clamp portion 5213 moves inward transversely to be disengaged from the first clamp portion 5114, to release locking of the first elastic assembly 51. The push rod 511 moves upward under the action of the elastic force of the first elastic member 512, and pushes the sliding member 40 to move, to push the upper cover assembly 20 and the heating assembly 30 to move.

Specifically, the first elastic assembly 51 and the second elastic assembly 52 may be mounted in the bracket assembly 60. The bracket assembly 60 may include a first bracket 61 and a second bracket 62 that are mounted fitting each other. The battery 70 and the circuit board 80 may both be accommodated between the first bracket 61 and the second bracket 62. A support member 66 may further be fixedly mounted in the bracket assembly 60, and configured to support the push rod 511 and the first elastic member 512. The push rod 511 may be vertically slidably disposed in the bracket assembly 60, and may include a first rod section 5111, a second rod section 5112, and a third rod section 5113 that are sequentially connected from top to bottom in an axial direction. An external cross-sectional size of the second rod section 5112 is greater than external cross-sectional sizes of the first rod section 5111 and the third rod section 5113. The bracket assembly 60 has a top wall 63. A through hole 64 for the first rod section 5111 to slidably pass through is opened in the top wall 63. A cross-sectional shape and a cross-sectional size of the through hole 64 may adapt to a cross-sectional shape and a cross-sectional size of the first rod section 5111. The first rod section 5111 passes through the through hole 64 and is pressed against a bottom wall of the sliding member 40, so that the sliding member 40 can be pushed to move upward.

The third rod section 5113 may be cylindrical, and a lower end of the third rod section 5113 may be vertically slidably sleeved in the support member 66. The first elastic member 512 may be a pillar-shaped spring and sleeved on the third rod section 5113, an upper end of the first elastic member 512 may be pressed against a lower end surface of the second rod section 5112, and a lower end of the first elastic member 512 may be pressed against an upper end surface of the support member 66. The first elastic member 512 has a compressed state and a released state. When the elastic mechanism 50 is in the locked position, the first elastic member 512 is in the compressed state. When the elastic mechanism 50 is switched from the locked position to the released position, a length of the first elastic member 512 increases to generate an elastic restoring force. The elastic restoring force acts on the push rod 511 to make the push rod move upward. In other embodiments, the first elastic member 512 may be a coil spring, an elastic sheet, a torsional spring, or another structure that can generate an elastic deformation, and the elastic deformation is generated to generate the elastic restoring force. The elastic restoring force acts on the push rod 511 to make the push rod move upward.

The first clamp portion 5114 may be formed on the second rod section 5112. The second rod section 5112 may be approximately a rectangular pillar. A side of the second rod section 5112 toward the locking member 521 may concave inward to form a slot 5115, so that interference between the second rod section 5112 and the locking member 521 can be avoided. The inner wall surface of the slot 5115 protrudes inward to form the first clamp portion 5114.

A press key 11 may be disposed on the shell 10 corresponding to the second elastic assembly 52. The press key 11 and the display 12 may be respectively disposed on two sides of the shell 10. When the press key 11 is pressed by an external force, the locking member 521 can be pushed to move inward transversely. After pressing is released, the locking member 521 and the press key 11 can move transversely outward and restore under the action of the elastic force of the second elastic member 523. The locking member 521 may include a main body portion 5211 and the second clamp portion 5213 formed by a side of the main body portion 5211 extending outward. The main body portion 5211 may be a rectangular tube. A side of the main body portion 5211 toward the press key 11 extends inward transversely to form a mounting hole 5212, used for mounting the second elastic member 523. A first guide slope 5116 and a second guide slope 5214 may further be respectively formed at a lower end surface of the first clamp portion 5114 and an upper end surface of the second clamp portion 5213. When the push rod 511 is pressed down, through the fitting of the first guide slope 5116 and the second guide slope 5214, the locking member 521 may be pushed to move inward transversely, so that the first clamp portion 5114 can move downward below the second clamp portion 5213 to be engaged with the second clamp portion 5213.

The second elastic assembly 52 may further include a mounting member 52 fixedly mounted in the bracket assembly 60. The mounting member 52 may be a sheet and used for limiting the second elastic member 523. The second elastic member 523 may be a spring and may be disposed in the mounting hole 5212. One end of the second elastic member 523 may be pressed against a hole bottom wall of the mounting hole 5212, and the other end may be pressed against the mounting member 52.

The sliding member 40 may be approximately an elliptic cylinder. The sliding member 40 is slidably mounted in the shell 10, and may slide back and forth between the first position and the second position. An accommodating hole 41 may further be formed longitudinally penetrating the sliding member 40, and the heating assembly 30 is sleeved inside the accommodating hole 41. A limiting structure may further be disposed in the sliding member 40, to limit a maximum upward movement position of the sliding member 40, to keep the sliding member 40 from being detached from the shell 10. The limiting structure may be fastened to the bracket assembly 60, and may include a limiting pillar 65 longitudinally slidably disposed in the sliding member 40 and a limiting member 45 extending transversely out of the limiting pillar 65. The limiting pillar 65 may be formed by the top wall 63 of the bracket assembly 60 extending upward. The limiting member 45 may be approximately a transversely disposed sheet, and may be fixedly mounted on a side of a top end of the limiting pillar 65.

The sliding member 40 may be pressed and mounted below the upper cover 21, and may be magnetically connected to the upper cover 21. When the sliding member 40 and the upper cover assembly 20 are at the second position, the upper cover assembly 20 is only partially exposed from the accommodating cavity 100 of the shell 10, and the upper cover assembly 20 is magnetically attracted to the sliding member 40 and kept from being popped from the accommodating cavity 100. A first magnetic member 23 used for being magnetically connected to the sliding member 40 may further be disposed in the upper cover 21, and/or, a second magnetic member 43 used for being magnetically connected to the upper cover 21 may further be disposed in the sliding member 40. The first magnetic member 23 may be a magnet and may be embedded at a bottom of the upper cover 21. The second magnetic member 43 may be a magnet and may be suspended in the sliding member 40, and may be fixedly mounted on a lower side of the limiting member 45. The limiting member 45 may be made of a magnetic material that can be attracted by the second magnetic member 43, for example, may be made of an iron material.

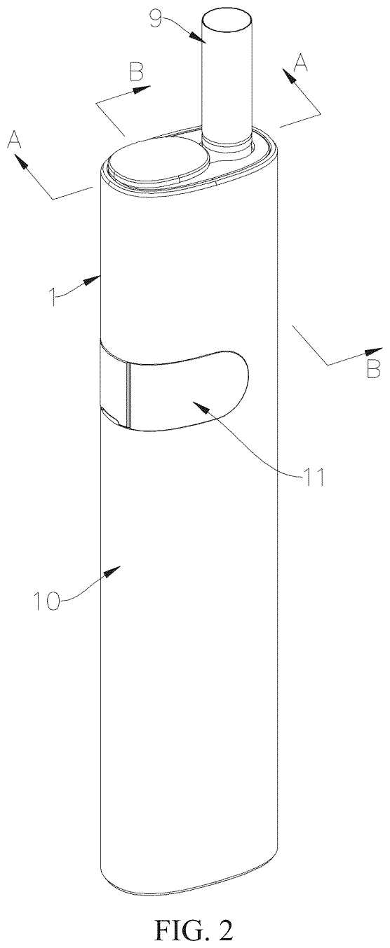

As shown in FIG. 2, FIG. 7, FIG. 9, and FIG. 10, during routine use of the aerosol forming device 1, the elastic mechanism 50 is in the locked position, and the first clamp portion 5114 of the push rod 511 and the second clamp portion 5213 of the locking member 521 are engaged with each other. The upper cover assembly 20, the heating assembly 30, and the sliding member 40 are all at the first position, and the upper cover assembly 20 and the sliding member 40 are attracted to each other by a magnetic force. The heating assembly 30 is located in the opening 101 of the accommodating cavity 100. The electrical contact 34 at a bottom of the heating assembly 30 is joined to and in conduction with the elastic electrode 81 disposed in the shell 10. An upper end surface of the limiting flange 313 at an outer edge of the heating tube 31 is pressed against the lower end surface of the positioning portion 211 in the insertion hole 210. A gap may be formed between a lower end surface of the limiting flange 313 and an upper end surface of the sliding member 40. In other embodiments, the lower end surface of the limiting flange 313 may be pressed against the upper end surface of the sliding member 40. The upper cover 21 may be completely accommodated in the accommodating cavity 100, and a top portion of the upper cover 21 may be located in the opening 101 of the accommodating cavity 100 or may be flush with the opening 101 of the accommodating cavity 100. In other embodiments, the upper cover 21 may be partially exposed from the opening 101 of the accommodating cavity 100. The dust cover 22 may be exposed from the shell 10, to facilitate operations of the user.

As shown in FIG. 8 and FIG. 11, after the aerosol forming device 1 has been used for a period of time and it is necessary to clean the heating assembly 30, the press key 11 in a surface of the shell 10 may be pressed inward to push the locking member 521 to move inward transversely, to enable the second clamp portion 5213 of the locking member 521 and the first clamp portion 5114 of the push rod 511 to be disengaged from each other. The push rod 511 moves upward under the action of the elastic force of the first elastic member 512, to push the sliding member 40, the upper cover assembly 20, and the heating assembly 30 to move upward to the second position. In this case, the upper cover assembly 20 and the heating assembly 30 are both partially exposed from the opening 101 of the accommodating cavity 100, and the upper cover assembly 20 and the heating assembly 30 may be sequentially removed, to clean the heating assembly 30 or replace a new heating assembly 30. After cleaning is completed, the heating assembly 30 and the upper cover assembly 20 are then sequentially mounted in the accommodating cavity 100, then the upper cover assembly 20 is pressed down to push the heating assembly 30 and the sliding member 40 to move downward to the first position again, and the sliding member 40 pushes the push rod 511 to move downward, to enable the first clamp portion 5114 of the push rod 511 and the second clamp portion 5213 of the locking member 521 to be engaged together again.

It may be understood that the foregoing technical features may be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aerosol forming device, comprising:
a shell formed with an accommodating cavity at an end;
a heating assembly detachably accommodated in the accommodating cavity; and
an elastic mechanism disposed in the shell,
wherein the heating assembly is formed with a heating cavity configured to accommodate an aerosol forming substrate,
wherein the elastic mechanism has a locked position and a released position, and
wherein, when the elastic mechanism is switched from the locked position to the released position, the elastic mechanism is configured to push the heating assembly to move toward an opening of the accommodating cavity.

2. The aerosol forming device of claim 1, wherein the heating assembly comprises a heating tube formed with the heating cavity inside and a heating element extending into the heating cavity.

3. The aerosol forming device of claim 2, wherein the heating element comprises a cylinder.

4. The aerosol forming device of claim 2, wherein the heating assembly comprises a base, and
wherein the heating element is fastened on the base and is accommodated in the heating cavity.

5. The aerosol forming device of claim 2, wherein an electrical contact electrically connected to the heating element is disposed on a surface of the heating assembly away from the heating element.

6. The aerosol forming device of claim 5, further comprising:
an elastic electrode disposed in the shell, the elastic electrode being configured for contact and conduction with the electrical contact.

7. The aerosol forming device of claim 1, further comprising:
an upper cover assembly detachably accommodated in the accommodating cavity, the upper cover assembly being formed with an insertion hole for insertion of the aerosol forming substrate,
wherein, when the elastic mechanism is in the released position, the elastic mechanism is configured to push the heating assembly and the upper cover assembly to move toward an opening of the accommodating cavity.

8. The aerosol forming device of claim 7, wherein an upper end of the heating assembly extends into the insertion hole, and
wherein the upper cover assembly abuts against the heating assembly and is configured to push the heating assembly to move away from the opening of the accommodating cavity to lock a position of the heating assembly in the accommodating cavity.

9. The aerosol forming device of claim 8, wherein an inner wall surface of the insertion hole protrudes inward to form a positioning portion,
wherein an outer edge of an upper end of the heating assembly protrudes outward to form a limiting flange, and
wherein the limiting flange is configured to be pressed by the positioning portion to push the heating assembly to move.

10. The aerosol forming device of claim 8, further comprising:
a sliding member slidably disposed in the shell,
wherein the elastic mechanism is configured to push the sliding member to move, to push the upper cover assembly and the heating assembly to move.

11. The aerosol forming device of claim 10, wherein the sliding member is magnetically connected to the upper cover assembly.

12. The aerosol forming device of claim 10, wherein an accommodating hole is formed in the sliding member, and
wherein the heating assembly is sleeved inside the accommodating hole.

13. The aerosol forming device of claim 10, wherein a limiting structure is disposed in the sliding member to keep the sliding member from being detached from the shell.

14. The aerosol forming device of claim 13, wherein the limiting structure is fastened to the shell, and
wherein the limiting structure comprises a limiting pillar slidably disposed in the sliding member and a limiting member transversely extending out of the limiting pillar.

15. The aerosol forming device of claim 14, further comprising:
a second magnetic member disposed at the limiting member and configured to attract the upper cover assembly.

16. The aerosol forming device of claim 1, wherein the elastic mechanism comprises a first elastic assembly configured to push the heating assembly to move and a second elastic assembly configured to lock or release the first elastic assembly.

17. The aerosol forming device of claim 16, wherein the first elastic assembly comprises a push rod vertically movably disposed in the shell and a first elastic member connected to the push rod,
wherein the second elastic assembly comprises a locking member transversely movably disposed in the shell and a second elastic member connected to the locking member, and
wherein, when the elastic mechanism is in the locked position, the push rod and the locking member are clamped with each other.

18. The aerosol forming device of claim 17, wherein a first clamp portion and a second clamp portion that are in snap-fit with each other are respectively formed on the push rod and the locking member, and
wherein the first clamp portion and the second clamp portion are engaged with or disengaged from each other to lock or release the push rod.

19. The aerosol forming device of claim 17, wherein a press key is disposed on a surface of the shell, the press key being configured to press locking member to enable the locking member to release locking of the push rod.

20. The aerosol forming device of claim 17, wherein the push rod comprises a first rod section, a second rod section, and a third rod section that are sequentially connected longitudinally from top to bottom, and
wherein an external cross-sectional size of the second rod section is greater than external cross-sectional sizes of the first rod section and the third rod section.
